(19) United States
(12) Patent Application Publication
(10) Pub. No.: US 2011/0196758 A1
(43) Pub. Date: Aug. 11, 2011

(54) INTELLIGENT BROADCAST TECHNIQUES TO OPTIMIZE WIRELESS DEVICE BANDWIDTH USAGE

(76) Inventor: Alexander E. Smith, McLean, VA (US)

(21) Appl. No.: 13/069,565

(22) Filed: Mar. 23, 2011

Related U.S. Application Data
(62) Division of application No. 12/203,166, filed on Sep. 3, 2008.
(60) Provisional application No. 61/013,654, filed on Dec. 14, 2007.

(51) Int. Cl. G06F 15/16; G06Q 30/00

(52) U.S. Cl. 705/26.7; 709/217

(57) ABSTRACT

A system and technique is described to enhance the use of limited bandwidth by intelligent broadcast, which would allow many more users to access content that was broadcast or downloaded by another user or group of users. While many users may download content that is specific to them, e.g., a flight itinerary, other users download the exact same content, e.g., a song or a movie, so the net result is that a significant portion of finite bandwidth is used repeatedly to download the same content. Furthermore, users, based on the type of user, or profiled users, will download the same content in the same general time period, for example, the release of a popular new album, movie or video. Content providers and wireless providers, who may be the same or different entities, may then share in the benefits of this approach, e.g., the savings in bandwidth usage and the improved distribution to the end user.

### CROSS-REFERENCE TO RELATED APPLICATIONS

The present application is a DIVISIONAL application of U.S. patent application Ser. No. 12/203,166, filed on Sep. 3, 2008 and incorporated herein by reference. That application in turn, claims priority from Provisional U.S. Patent Application Ser. No. 61/013,654, filed on Dec. 14, 2007, also incorporated herein by reference.

### FIELD OF THE INVENTION

The present invention relates to the field of network management. In particular, the present invention is directed toward a method and apparatus using techniques to optimize bandwidth usage in networks.

### BACKGROUND OF THE INVENTION

Broadcasting, as we know it, may be coming to an end. The concept of broadcasting, first in radio, and then in television, could be said to have been invented by David Sarnoff, head of Radio Corporation of America (RCA) and founder of the National Broadcasting Company (NBC). Prior to his involvement with RCA, radio was considered a point-to-point two-way communications device, similar to the telegraph (hence the term “wireless” or “wireless telegraph”). The idea of a single broadcasting station or network sending the same content to a number of simple receiving sets revolutionized the radio business and also our culture.

The advent of newer communications networks, such as the Internet, and increasingly, multimedia communications devices such as media-enhanced cellular phones, threatens to spell the end of conventional broadcasting. Instead of turning on the television and “seeing what's on,” today's users are increasingly turning on their computers and deciding what to watch. Users are no longer tied to the concept of broadcast time-slots, television “seasons” and the like. Users can watch what they want to watch, when the want to watch it.

However, despite the enormous amount of media content available on the Internet, users tend to follow certain patterns of consumption. Popular movies and recent releases tend to be viewed by a large number of people within a certain time period, particularly if the content has been heavily promoted. Users tend to trend toward certain content types and genres as well. Thus, despite the enormous choices available from Internet-based media, users tend to follow well-worn paths.

Determining which content to watch can be daunting. Moreover, in the absence of traditional broadcasting channels, content providers may find it difficult to advertise their content to interested viewers though the background noise of all these choices. A means for aiding in the selection of content, as well as an improved method of intelligently broadcasting content to users remains a requirement for this new art.

Advertising in the traditional sense, however, is less than effective in promoting media consumption. Users view advertisements for unwanted content as annoying. On the other hand, the same users will find advertising for desired content as timely and useful. Targeting users for advertising content results in a more efficient use of advertising revenues and also results in better feedback from users. Major search engines (e.g., Google™ and the like) as well as other web sites (e.g., CNN website) are already using such targeted advertising, by using user search terms or article selections to select corresponding banner advertisements, pop-up ads, sidebar ads, or the like. Given the large amount of clutter on the Internet, a targeting method of reaching consumers with media content would be desirable.

Ironically, networks such as cellular phone networks (GSM or 3G or the like) and cable modem communications, satellite broadband, fiber optic, and the like, while acting a point-to-point two-way communications networks, are actually broadcasting networks. As many politicians and celebrities discovered to their dismay, Prior Art analog cellular telephone networks broadcast voice signals such that anyone with a radio receiver could receive them. The cellular devices themselves were merely programmed to play only that audio content intended for that device.

Modern digital cell phones have solved this problem, as the audio signal is digitized and then encrypted, such that only the device for which the signal is intended may decrypt and playback the signal. However, the encrypted digital signal is still available for anyone to intercept via a radio receiver—although decrypting such data may be very difficult. In a similar manner, many broadband services, including but not limited to cellular modem, satellite broadband, fiber optic, and the like, may also broadcast data in a manner than any user can intercept it, with proper tools. However, again since the data may be encrypted, it is difficult for other users to intercept the data.

Shared networks like this determined which devices are to receive the data by indicating, via a digital tag or the like, which devices on the network are to receive the data. In present-day applications, each device may receive data intended for other users on the network, but will only download and decrypt data intended for the user of a particular device. However, it is technically feasible for multiple users to download and decrypt the same data from the same data stream on a shared network. Thus, the point-to-point networks of the Internet and cellular phones could be used as broadcasting networks. However, to date, no one has taken serious advantage of this broadcasting aspect of these new networks.

Mike Daniels, in a published interview with TechBisNow, distributed on Oct. 19, 2007, incorporated herein by reference, stated that with mobile devices outnumbering computers by a factor of two or three, he sees a gigantic market—and huge opportunities for firms that marry wireless devices with web-based and other applications. Other industry analysts predict that wireless devices will outnumber computers significantly over the next several years.

The growth in this industry segment has spawned opportunities for companies situated between the users and content providers. For example, Sybase, of Dublin, Calif., (Website at sybase.com, incorporated herein by reference), is a company that provides mobile messaging services, and, according to its website reaches more than 1.7 billion mobile users globally −77 percent of the world's current subscribers. Sybase represents a new provision of service, from the delivery and settlement of mobile messaging interoperability to the management and distribution of mobile content via Short Message Service (SMS), Multimedia Messaging Service (MMS) and Wireless Application Protocol (WAP). According to the company, Sybase 365 processes more than 6 billion messages monthly and is positioned between mobile operators, enterprises, global brands, and mobile content providers. The company offers services to facilitate mobile data and content delivery, as well as complete backend payment and settlement solutions. Sybase 365's global interoperability is advertised as providing uninterrupted SMS and MMS messaging between technically disparate and geographically dispersed networks.

In an article titled Off the Hook in the July, 2007, edition of the IET's Engineering and Technology publication, incorporated herein by reference, Walter Tuttlebee, Chief Executive of Mobile VCE, a strategic research organization for mobile operators and equipment suppliers, presented scenarios for future supply of personalized lifestyle services using cell phone features. Tuttlebee described the following scenario for a customer with a personal profile: The customer syncs his phone with his PC so that when he flies from London to Brazil his e-ticket arrives in his e mail inbox and automatically gets transferred to his phone. His handset knows which day he will be flying from Heathrow, so it caches the map to get the driving directions. It books his parking space at the airport and it registers when he arrives at the airport and checks him in automatically. He then gets an acknowledgement on his phone, which he uses to hold up to a scanner to check his luggage for the flight. When he arrives in Brazil the system loads the directions to get the bus or taxi to the hotel. When he gets to the lobby it registers that he has arrived at the hotel, automatically checks him in, and downloads an electronic key to his phone. He walks to the room where the TV has already been automatically set up to all of his home channels. All of the above happens automatically without requiring user input throughout the process.

In the Article Into the Frontline published in the August/September 2006 issue of the IET Engineering Management magazine, incorporated herein by reference, Paul Clapman discusses cell phone product development. He cited cell phone product development as falling into the school of “because we can.” He stated that mobile phone functionality “increases exponentially but for the vast majority of users most of those functions are used little or not at all. How many owners actually need the telephone equivalent of a Swiss army knife which, as well as sending and receiving calls and text, can send e mails, download music, take photographs show movies and TV? His answer was “very few.” “But enough people want that level of perceived technical advancement to create the market,” he added. “Those added functions create opportunity for brands to increase their share of shout in a buoyant market and they are an awful lot easier to sell than excellent reliability or premium quality of reception. Certainly in this instance customers value ‘more’ ahead of ‘better.’”

A good example of a state-of-the-art cell phone is the Apple iPhone. In a review by CNET, Apple iPhone 0 8 GB (AT&T), 2007, incorporated herein by reference, many of the new features provided by the Apple iPhone were described. While the iPhone received much attention from the public, it provided many new cell phone features but also omitted other features that were generally expected in state of the art devices. Features that were not included in 2007's first generation iPhone included multi-media messaging and 3G capabilities. Also, the phone was essentially locked into one network provider (AT&T in the U.S. and others in various different countries) when initially released, although the company subsequently advertised plans to unlock the phone.

From a design point of view, the iPhone had no external antenna and no buttons, relying on a versatile touch screen display. The CNET reviewer pointed out that although the Apple handset is not the first cell phone to rely solely on a touch screen, it is the first phone to get so much attention and come with so many expectations in the market. Depending on what the user is doing, the touch screen serves as the dial pad, keyboard, Safari web browser, and music and video player. The reviewer went on to state that the iPhone offers a full range of wireless functionality with support for Wi-Fi and Bluetooth connectivity. The Wi-Fi compatibility is especially welcome, stated the reviewer, and a feature that's absent on far too many smart phones. The iPhone's 2-megapixel camera records still images but not video surprisingly, although that is fast becoming a standard feature on many cell phones. Also, the iPhone includes a fully functioning fifth-generation iPod for music. The bundled features include visual voicemail, and a built-in Google Maps application, although no GPS.

Third Generation, or 3G, technology is the latest in mobile communications while analog cellular technology may be considered to be generation one and digital/PCS generation two. 3G technologies are intended for multimedia cell phones and feature increased bandwidth and transfer rates to accommodate Web-based applications and phone-based audio and video files. 3G comprises several cellular access technologies including:
CDMA2000—based on 2G Code Division Multiple Access
WCDMA (UMTS)—Wideband Code Division Multiple Access
TD-SCDMA—Time-Division Synchronous Code-Division Multiple Access

For a good description of each of these technologies, refer to: the website electronics.howstuffworks.com/cell-phone5.htm incorporated herein by reference.

3G networks have potential transfer speeds of up to 3 Mbps (about 20 seconds to download a 4-minute MP3 song). For comparison, the fastest 2G phones can achieve up to 144 Kbps (about 10 minutes to download a 4-minute song). 3G's high data rates are ideal for downloading information from the Internet and sending and receiving large, multimedia files. 3G phones are like mini-laptops and can accommodate broadband applications like video conferencing, receiving streaming video from the Web, sending and receiving faxes and instantly downloading e-mail messages with attachments.

The daily electronic news e-mail, DailyTechRag, [editors @dailytechrag.com] dated Oct. 22, 2007, incorporated herein by reference, stated that WiMAX has been officially certified as a 3G standard by the UN's International Telecommunication Union. According to the source, this means that WiMAX is now the sixth official form of 3G technology, and that WiMAX can now legally use airwaves that have been designated for 3G use.

In an article Up The Revolution in the January 2007 IET Magazine of Engineering and Technology, incorporated herein by reference, William Webb, a fellow of the IET and the Royal Academy of Engineering, attempted to predict the overall direction of the wireless communications industry over the 20 years. He forecasted that in fixed networks he expects IP-based core networks to be deployed, with more fiber to the curb, and in some cases to the home. He predicts that personal video recorders will be used to assemble personal channels from a range of sources, reformat the content and distribute it to handsets and other portable devices by around 2020. Conversely, he predicts little change in cellular apart from increased coverage and capacity as cell sizes shrink.

Specifically, Webb does not see a new technology such as 4G being deployed in the next 20 years. Handsets, he predicts, will see incremental enhancements in displays, storage capacity and functionality, including much better speech recognition. Users, Webb predicts, will see a steady but substantial change over the next 20 years and will rely on the handset for as a single device to manage not just communications but many aspects of their lives. Users, he predicts will see the world as one large communications network, able to provide them with whatever content they need wherever they are.

It is therefore logical to predict that bandwidth capacity of data networks and cellular bandwidth will be a key issue going forward or a limiting factor, as we have a possible scenario of the basic 3G infrastructure supporting exponential growth in applications for the foreseeable future. Furthermore, techniques for bandwidth management will continue to play a key role in the developing data communications infrastructure for messaging and content delivery.

At the same time, the amount of memory (storage) available in handheld devices has increased significantly—often beyond the needs of the users. While the demise of rotating magnetic media (hard disk drives or HDD) has been predicted for years, continual advances in HDD technology have resulting in smaller and less costly devices with greater and greater memory capacities. Thus, from the standpoint of hand-held media devices, the limiting factor for transmitting and playing back media files lies more in bandwidth limitations than in any limitations in storage capabilities.

A fundamental tool for bandwidth management is data compression. A good description of compression techniques is provided in Tom Sheldon's 2001 book, The Encyclopedia of Networking and Telecommunications, incorporated herein by reference. Lossy and lossless compression techniques are employed for data transfer depending on the application (e.g., video and audio are transmitted with some form of lossy compression, while other files may be transmitted with lossless compression). Lossy compression can offer up to 200:1 compression while lossless compression usually only achieves a 2:1 ratio. Compression techniques include null compression, run length compression, keyword encoding, and adaptive Huffman coding and Lempel-Ziv algorithms.

For example, as described on Cisco's website: http://www.cisco.com/warp/public/cc/pd/iosw/tech/compr_wp.htm, incorporated herein by reference, Cisco uses STAC and Predictor compression algorithms, which are based on the Lempel-Ziv compression algorithm. The Cisco router software uses an optimized version of LZS that provides good compression ratios but requires many CPU cycles to perform compression. LZS is available in Cisco's Link Access Procedure, Balanced (LAPB), HDLC, X.25, and frame relay data compression solutions. While these techniques offer anywhere from 2-200:1 compression, available bandwidth capacity is still a significant pacing factor for the industry.

In an article in the October 2007 edition of the IET magazine, incorporated herein by reference, David Sandham reported on the 2007 International Broadcasting Convention, IBC2007. Sandham comments that Internet Protocol (IP) is fast becoming the de facto standard for all forms of communications including video. Called IPTV, for Internet Protocol Television, the format allows for the tailoring of content to individual users, as individual programs may be sent to small groups or individual users. Sandham went on to report on the compression techniques used by IPTV, starting from MPEG-2 five or six years ago, and now MPEG-4 which brought bandwidth savings of the order of 50% over MPEG-2.

In Ben Patterson's Blog, dated Oct. 12, 2007, http://tech.yahoo.com/blogs/patterson/7269, incorporated herein by reference, he provides a review of a TV set-top box that uses peer-to-peer networking to deliver near-DVD quality videos. The product is called Vudu, containing a 250 GB hard drive, which is enough for 100 hours of standard-definition movies. The company offers 5,000 movies in an “on demand” format, to use the terminology used by conventional cable and satellite TV providers. Patterson notes that while most Internet-connected set-top boxes take upwards of 20-plus minutes to download a two-hour standard-def movie, the Vudu starts playing immediately. It does this by being pre-loaded with the first 30 seconds of the most popular movies. The headers download in the background onto unused portions of the hard drive, and due to peer-to-peer networks, each Vudu box shares the load in terms of downloading any given movie.

Peer-to-peer (or P2P) networks use diverse connectivity between network participants and the cumulative bandwidth of network participants rather than conventional centralized resources where a relatively low number of servers provide the core value to a service or application. Peer-to-peer networks are useful for sharing content files containing audio and video and real-time data, such as telephony traffic, is also passed using P2P technology.

The company, Vudu, (See, www.vudu.com, incorporated herein by reference), requires a minimum available bandwidth of 2.0 Mbps (usually advertised by ISPs as 3.0 Mbps, according to Vudu) for instant viewing of movies. Note that all references here are for standard definition, i.e., 480p, and not 1080p high definition formats, which will require higher bandwidth and capacity. Patterson, in his review referenced above, cites a period of several hours to download high definition movies to an Xbox.

While in this example peer to peer allows for distributed sources of content, it does not necessarily cut down on the use of overall bandwidth by a particular user, and that user is limited by the lowest bandwidth point in the network, e.g., normally from the home to the ISP provider for residential users.

There are other various techniques available to optimize the use of bandwidth. In U.S. Pat. No. 7,283,491, “Communication System and Method Capable of Broadcasting by Using Terrestrial and Satellite Communication Networks”, incorporated herein by reference, a system for using satellite and terrestrial networks as an adjunct to the Internet for multi-casting is described. The main feature described is the use of unused time slots to multicast information such as movies, thereby making use of otherwise unused bandwidth capacity.

Another technique, in Published U.S. Patent Application 2007/0240185, entitled “Methods, Apparatuses, and Computer Program Products for Delivering Audio Content on Demand”, incorporated herein by reference, describes a system for providing audio on demand. Specifically, the patent application describes a method of delivering on-demand audio content, comprising reception of a selection of audio content for listening to on-demand while receiving an input specifying delayed listening and determining that the audio content is to commence before expiration of a predetermined time interval. If that time interval has not expired, other listeners may join in the multicast. If the time interval expires, then the single user requesting the audio on demand can listen to the audio, in unicast, albeit slightly delayed. This technique improves upon bandwidth usage by straight unicast by multicasting to users who opt to receive the content simultaneously.

U.S. Pat. No. 6,466,918, entitled “System and Method for Exposing Popular Nodes Within a Browse Tree,” incorporated herein by reference, describes a method for identifying popular nodes within a browse tree or other hierarchical browse structure based on historical actions of online users, and for calling these nodes to the attention of users during navigation of the browse tree. While this is tailored for an on-line store, such as that provided by Amazon, it is one of many techniques to identify user preferences based on previous user selections and transaction history.

This type of technique may be extrapolated to identify potential users of specific broadcast download content, i.e., those users who may like a particular actor, actress, or performer in a video or audio presentation.

Marks, U.S. Pat. No. 6,463,447, issued Oct. 8, 2002 and entitled “Optimizing bandwidth consumption for document distribution over a multicast enabled wide area network” and incorporated herein by reference, discloses a method for filtering documents. Marks receives a document off of a multicast channel and determines whether the document includes relevant information. A filtering agent retrieves meta data from the document. An evaluation unit whether the document includes relevant information based on session identification, Meta data, and source information. Marks discloses his “documents” can include media files. However Marks requires an extensive filtering regime to determine whether a document should be loaded into a user's computer.

Mover, this filtering regime takes place on the user's computer, which requires that the user receive all file metadata, filter the data, and then decide whether to download the data. The use of metadata, while intending to save on processing time, bandwidth, and memory, actually ends up burdening the processor and end device, as the device must check each file being sent over the common data path and then determine whether the meta data indicates the file should be downloaded. While the Marks system might work in a cable modem environment where a number of computers are connected to a common data link (coaxial cable), such a filtering scenario might not be as workable with portable wireless devices such as portable media players and the like.

### SUMMARY OF THE INVENTION

A system and technique are described to enhance the use of limited bandwidth by intelligent broadcast, which would allow many more users to access content that was broadcast or downloaded by another user or group of users. While many users may download content that is specific to them, e.g., a flight itinerary, other users download the exact same content, e.g., a song or a movie, so the net result is that a significant portion of finite bandwidth is used repeatedly to download the same content. Furthermore, users, based on the type of user, or profiled users, will download the same content in the same general time period, for example, the release of a popular new album, movie or video. Content providers and wireless providers, who may be the same or different entities, may then share in the benefits of this approach, e.g., the savings in bandwidth usage and the improved distribution to the end user.

The present invention is different from the peer-to-peer (P2P) approach used by Vudu, discussed previously, which basically relies on distributing the source of content through various users. Intelligent broadcast transmits or broadcasts content, or partial content, simultaneously to groups of users, much in the way conventional radio or TV is broadcast, but over various communications systems based on the preferences exhibited by those users, or other user profiling.

Unlike the Marks Patent, discussed previously, the present invention does not require filtering of meta-date or other actions in order to determine content suitability. Rather, it is the system itself, in the form of a broadcast profiler, that may select which users are most likely to select the broadcast content and thus direct the transmission to the users most likely to use the content. The user device does not have to perform any filtering of metadata or other data, as the media is directed toward the user from the system, based on user behavior patterns, rather than the user's device selecting based on user-input preferences.

The present invention may be applied to wireless devices such as mobile phones with built-in capability to play music or view video, or other types of portable media players and the like either already in production or shortly to be introduced. Note that in the present description, the device is described as being used with a portable media player such as a mobile phone. However, with the rollout of wireless broadband, such devices may also be non-portable devices for use in the home, or media players built-in to automobiles or other vehicles.

In another embodiment of the present invention, fixed-base users such as computers, televisions, home theater and game consuls may employ intelligent broadcast to minimize bandwidth usage locally, regionally, and nationally. In this embodiment, intelligent broadcast may be used on a common data path (wireless broadband, cable modem, fiber optic, or the like) where a number of user computers may be connected to a common data path. However, unlike the Prior Art Marks Patent discussed above, the user destination is determined at the system level, not by using meta data at the user level.

### BRIEF DESCRIPTION OF THE DRAWINGS

FIG. 1 is a block diagram of the first embodiment of the present invention for intelligent broadcasting of content over networks.

FIG. 2 is a block diagram of the second embodiment for streaming of real-time content to mobile devices at a stadium.

### DETAILED DESCRIPTION OF THE INVENTION

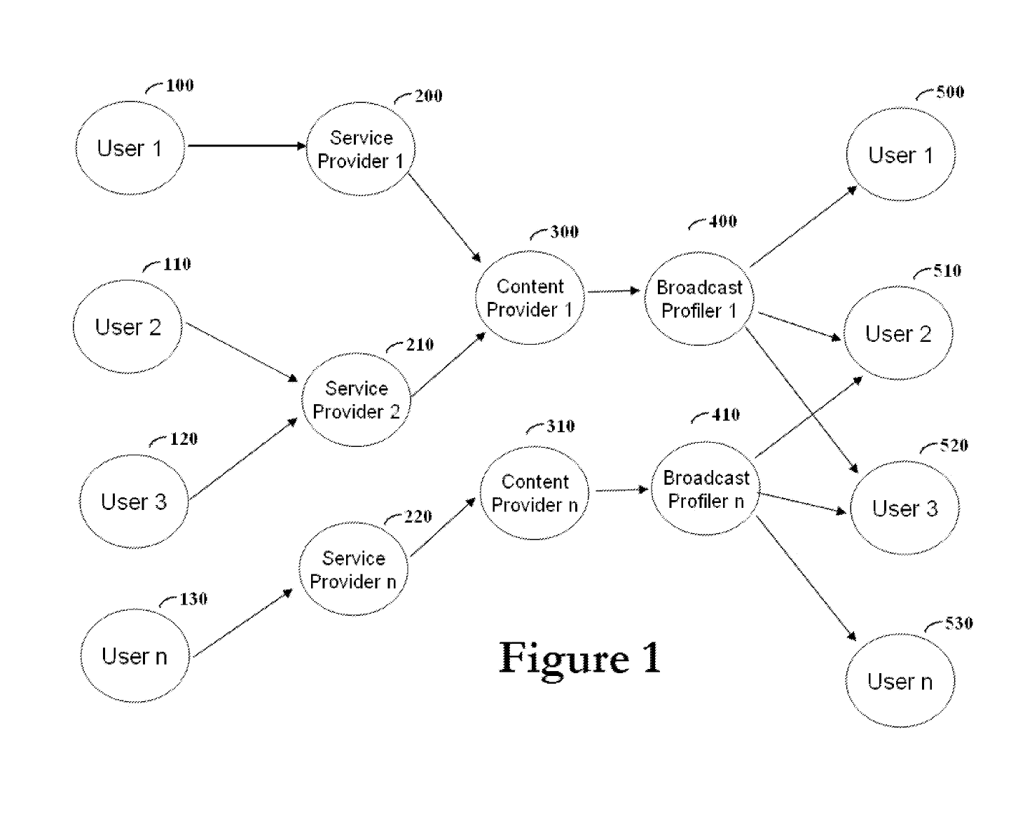

Referring to FIG. 1, in the preferred embodiment of the present invention, a system is shown for intelligent broadcasting of content to mobile devices. Again, please note that the present invention is described in terms of mobile devices, but may be applied to home computers and other entertainment devices as well. Thus, the present description of FIG. 1 in terms of mobile devices should not be construed as limiting the present invention to that embodiment, but is provided by way of illustration only.

The users, using mobile devices 100, 110, 120, 130, make requests to download content from their respective service providers 200, 210, and 220. Mobile devices in this example may include media-compatible portable devices such as an Apple™ iPhone™ or the like. The requests may be made by the users independently and unsynchronized in time, and may be for different content. For example, one user may request an audio file, such as a new music album, at 10 AM and another user may request a video file, such as a movie, at 10:30 AM.

User requests for content are passed from the service providers 200, 210, 220 to the content providers 300, 310. Service providers 200, 210, and 220 may comprise, in this example, cellular telephone service providers, which provide cellular telephone communications services to users 100, 110, 120, and 130. Content providers 300, 310 may be music or video stores, such as Apple's iTunes™, Amazon, and the like. Content providers 300, 310 may be linked to service providers 200, 210, and 220 via an interface on the user's phone, such that the user can visit the Content provider's “store” through the user's phone. If the phone is provided with web-browsing capability, the content provider may comprise any web-based media or other provider.

Content providers 300, 310, either independently or in conjunction with other parties, such as service providers 200, 210, 220, will update broadcast profilers 400, 410 based on the new requests for content. Unlike traditional profiling techniques that identify popular nodes within a browse tree for a specific user, the profiler identifies other users with similar selection histories.

Thus, for example, broadcast profilers 400, 410 may be programmed to review the history of media selections by users 100, 110, 120, and 130. Similar algorithms are already known in the art and are presently used by Amazon™ and Netflix™ to suggest to users, based on previous selections, additional media content may be of interest. Thus, for example, if a user selects a number of foreign language films, the algorithm may suggest to the user additional foreign language films of interest. The algorithm may be further fine-tuned by other categories as well, such as action films, romance, film noir, art films, drama, director, actor, and the like.

This algorithm may be operated by consulting a metadata database, which provides a lookup of metadata tags based upon the name of the media content. For example, the film “Rambo” may have associated metadata including the genre “Action/Adventure” as well as actor and director names, and other indicia. This metadata need not be attached to the media file itself (which may comprise, for example, an MPEG file or the like), but can be retrieved from a lookup table accessed by the content title or other indicia (catalog number, ISBN or the like).

Thus, unlike Marks, which requires that metadata be inserted into the file before transmission, the present invention can retrieve metadata from independent data sources (e.g., Imdb™, the Independent Movie Database). And unlike the algorithm used by Amazon™ Netflix™ and others, in the present invention, the algorithm selects users interested in the content, instead of content which may be of interest to the user. This identification is achieved by reviewing the user's past purchase or request patterns. It also may be modified by the user indicating a preference for certain content types or the like. However, unlike Marks, this content preference is uploaded from the user device to broadcast profilers 400, 410, such that filtering of content need not take place at the user device.

Profilers may also make use of information from third party applications such as browsers or search engines to indicate preference for media content. Thus, for example, a user may be surfing the web for information regarding a certain actor, director, film genre, author, or actual film title. The user has not requested this content to be downloaded to his device. However since the user has searched for this content or similar content, it may be inferred that similar content may be of interest to the user based on browsing history.

Broadcast profilers 400, 410 identify a group of mobile device users for simultaneous reception of the requested content, via the service providers. FIG. 1 shows broadcast profiler 400 identifying mobile device users 500, 510, 520, and broadcast profiler 410 identifying mobile device users 510, 520, 530. Note that users 500, 510, 520, and 530 may or may not be the same users 100, 110, 120, and 130 requesting content.

Service providers 200, 210, 220 or the content providers 300, 310 simultaneously broadcast a complete copy or a partial copy of the requested content to each group of mobile device users 500, 510, 520, and 530. The simultaneous broadcast, or “multi-cast” transfers the content to multiple users, who may or may not choose to access the content through some means of payment or other authorization. This allows the content providers 300, 310 mass access to users and to potentially use less service provider bandwidth 200, 210, 220 to distribute files.

Mobile device users 500, 510, 520, 530 may access the broadcast content at any time after the broadcast has commenced. Users who did not specifically request to download the content may receive partial downloads, such as the first half of an album or movie, depending on user preferences or available cache memory in the mobile device.

If the user who did not specifically request to download the content later decides to select the same content for download and/or purchase, the content is already located on his device (in whole or part) and thus no additional bandwidth (or less additional bandwidth) is required to transmit the content to that user. If the user who did not specifically request to download the content does not decide to download and/or purchase that content, the content may remain in the user's device for a predetermined period of time, or until space in the device is needed for further content or data. At such a time, the unpurchased or unselected content may then be deleted from the user's device.

An example of the operation of the system of the present invention is as follows. Users 100, 110, 120 and 130 make content requests through their mobile devices, which may comprise, for example an Apple™ iPhone™ or the like. In this example, users 100, 110, 120, and 130 may be requesting a recent film release, such as the new James Bond film, “Quantum of Solace.” Service providers 200, 210, and 220 process these requests to content providers 300, 310. Content providers 300, 310 may comprise an online media store such as Amazon™ iTunes™, Netflix™ or the like, which provide media (movies, television programs, books, music, video games, and the like) to end users over Internet or other connections.

Content providers 300, 310 prepare to transmit the media files to the users 100, 110, 120, 130 which requested the files. However, since these files are to be sent over a common data path, such as a cellular network or cable modem or the like, any user on this data path may be provided with access to the file. Downloading all files to all users may be cumbersome and use up user memory on the user device rather quickly. Filtering at the user device using metadata as suggested by Marks may be cumbersome, as the user device needs to monitor all content and decide whether to download the data.

Broadcast profilers 400, 410 may “profile” users 500, 510, 520, and 530 as being customers potentially interested in the content being transmitted. In this example of the James Bond film, once it is released on iTunes™ or another online store, there may be significant demand, particularly if it is a new release. In the Prior Art, each request for this media content by users would require a separate download of the media file, resulting in a horrific waste of bandwidth, as the same media file is downloaded over the common data link over and over again—literally thousands, if not millions of times.

Broadcast profilers may decide that users 500, 510, 520, and 530 are interested in the content based on a number of criteria. For example, user 500 may have previously purchased other James Bond films for download to his device. User 510 may have downloaded Daniel Craig movies in the past or movies directed by Marc Forster. User 520 may have performed a search on the terms “James Bond”, “007”, “Daniel Craig”, or “Marc Forster” in the last 30 days. User 530 may have visited the movie's website or viewed web pages related to the movie. Or any of the users 500, 510, 520, and 530 may simply have indicated an interest in Action/Adventure movies as indicated by previous purchases. And of course, any combination of these actions or similar actions may be used by broadcast profilers 400, 410 to determine which users may be interested in the content.

Not illustrated in FIG. 1 are users who are not selecting the content and/or are not targeted by broadcast profilers 400, 410 to receive the content on their mobile devices. A user who expresses interest only in costume dramas, for example, might be filtered out as not be interested in loud action/adventure films. Additionally, users may upload a preference indicator to opt out of such intelligent broadcasts, and thus be excluded from consideration.

Various forms of opt-out, opt-in, negative option, and the like, may be used to include or exclude users as well. In one embodiment, users may opt-in to intelligent broadcast by selecting such an option on their media device or by visiting a website or the like. The motivations for opting-in to such a service includes the ability to more quickly download media content, and also to have media content suggested to the user based upon their preferences. In addition, users may be encouraged by special pricing discounts and other incentives (credits toward future media purchases, and the like). By opting-in to such an arrangement, the user may agree (in a Terms of Service or TOS statement) to waive certain privacy rights by allowing broadcast profilers 400, 410 to (anonymously) monitor the user's media usage for filtering purposes.

Note also that media and content providers (e.g., movie studios and the like) may pay fees to have their content intelligently broadcast to user devices, in order to encourage consumption of media. Such financial incentives may be used to offer reduced prices for selected media to end-users. Once a media file is loaded to a user's device, a message may appear on the user's device announcing or advertising the content. The user may then be encouraged to play the content, at which point his device will be billed for the content. The user receives the content faster and more easily than a Prior Art manual download, and at a possible lower cost to the user. The service provider saves on bandwidth by broadcasting the same media file once to a number of users instead of individually to each user. And the content provider sells more copies of the content to end users as the file is automatically loaded to the user, encouraging impulse purchases, and moreover the filtering technique allows for better targeting of audience for media content.

Thus, in the present example, once users 500, 510, 520, and 530 have been targeted as being receptive to the new James Bond movie, the media file (MPEG or the like) is then sent over the data path (cable modem, GSM, or the like) to the users 100, 110, 120, 130 who selected and ordered the film, and also to the targeted users 500, 510, 520, and 530 who may be interested in viewing the film as well. Since the media file is sent over a common data path, the file may be transmitted once, but received by a plurality of users, thus saving on bandwidth. Users 100, 110, 120, and 130 may commence watching the video at a time of their choosing or save it on their media device for later playback.

If one of users 500, 510, 520, and 530 decide to order the film, it may play immediately, as it is already loaded on the user's device. Alternately, the user device may send a message to the user (as a text message, voicemail, graphic, or video) indicating that the file is available for immediate playback. For example, when the media device is activated, a trailer for the film may play, enticing the user to playback (and thus purchase) the entire media file.

The present invention operates in a manner transparent to the end user. That is, the downloading of unselected content is automatic to the device and does not require any intervention by the user. If the user selects to purchase or download content that has already been loaded to his device, the content will be enabled, and the user will benefit from nearly instant access to the content in question, rather than waiting for a new and complete download of the content. Similarly, if the user does not select the content for download or purchase, the content may later be deleted from his device without the user ever knowing that the content was on his device, and without the user having to intervene in the process.

To prevent users from “hacking” into unpurchased content downloaded to their device, any number of techniques may be used to encrypt such data using keys and the like to prevent the user from unauthorized access to the content until it is purchased or selected. In this manner, users will not be able to illegally access copyrighted or confidential material stored on their device.

While described in the context of downloading movies and videos and other Internet content, the present invention may also be used in other contexts. For example, map data may be downloaded to a group of users in a geographical location for use in mapping software on a portable device (e.g., GPS enabled device or the like). For users selecting a mapping function, this map data may be enabled (purchased or otherwise enabled, for example, as part of a mapping service). For users not selecting this feature, such data may be discarded. Thus, the present invention not only saves in bandwidth of transmission, but also in memory usage for user devices.

Similarly, the present invention may be used to distribute data to members of a group using a common database. For example, employees of a company may receive updated data relating to their company (order and sales data, project data, and the like) automatically loaded into their devices using common bandwidth. Employees who use such data will enable those portions of the data, which will be saved to the device. Data that is not used or enabled may be later deleted to make room for new data transmitted to the group.

In other scenarios, data may be transmitted to a group of employees, such a delivery service employees (e.g., UPS, FedEX, and the like), including common data for tracking packages, and the like. Again, employees who use particular data will enable that data which may be saved for a period of time, or until the data is no longer needed (i.e., package delivered). Data that is not used or enabled will be deleted sooner.

While the example of movie files has been used herein, other types of data and media may also be used. For example, similar filtering techniques or preferences could be used to download books to a user's device using user preferences, either inferred from user purchases and actions or by preference (e.g., New York Times best seller's list, Mysteries, Romance, Suspense, Novels, Political, Humor, Author, or the like). Thus, a user could have instant access to a number of books of interest, without having to download each of them manually. In addition, publishers can use the present invention to promote books to interested readers in a targeted manner.

Similarly, music files from such stores as iTunes™ could be automatically downloaded to a user's device using selection criteria (e.g., by category, such as Top 40, Adult Contemporary, Country/Western, Rock, Hip Hop, or the like, or by Musician, Group, Composer, or the like). In this manner, music could be made available to a user and promoted to interested users.

Note also that the present invention is useful for users who are out of touch with the network for periods of time. In some areas, network reception may be limited or impossible, or bandwidth may be too limited to download media files. Alternately, users may be roaming on competing networks where bandwidth may be costly. In some buildings, reception may be difficult. On airplanes, users are not presently allowed to use cell phones, although in-flight cell phone and broadband communications are presently contemplated. Even on aircraft allowing for cell phone or broadband communications, data bandwidth may be limited for media downloads.

Since the present invention has already downloaded media to a user's device, new media may be available to the user without having to access the network, or in a network of limited bandwidth. In the latter scenario, if only a portion of the media file has been downloaded, the remainder can be downloaded in a timely manner on a network of limited bandwidth, such that the user has an uninterrupted use of the media.

As noted previously, the present invention may download the entire media file, or just portions thereof (chapters, or the like). The user device may manage unused memory such that non-requested media files occupy unused space. As more memory in the device is required for the user, non-requested media files may be deleted on a FIFO (First In First Out) basis or using other criteria. In this manner, the amount of memory “used” by non-requested media does not even appear to the user, and thus his media device memory is not overloaded by un-requested media.

Note that in the previous description, downloading of media content is initiated by users 100, 110, 120, and 130 who request such content. However, it is within the spirit and scope of the present invention to provide such content even in the absence of such download requests. Content providers 400, 410 may intelligently broadcast media to users 500, 510, 520, 530 based on profile preferences. In this manner, content providers 400, 410 may be able to send out “new releases” or promoted media, even in the absence of requests for such media.

In addition, the service providers 200, 210, 220 may utilize off-peak bandwidth to transmit such promoted media to users. Since such media is not being broadcast in response to a specific request, it may be transmitted at times when network data usage is at its lowest (e.g., 3 AM). Thus, while a user's media player is recharging overnight, it also may be downloading new media content which may be of future interest to the user.

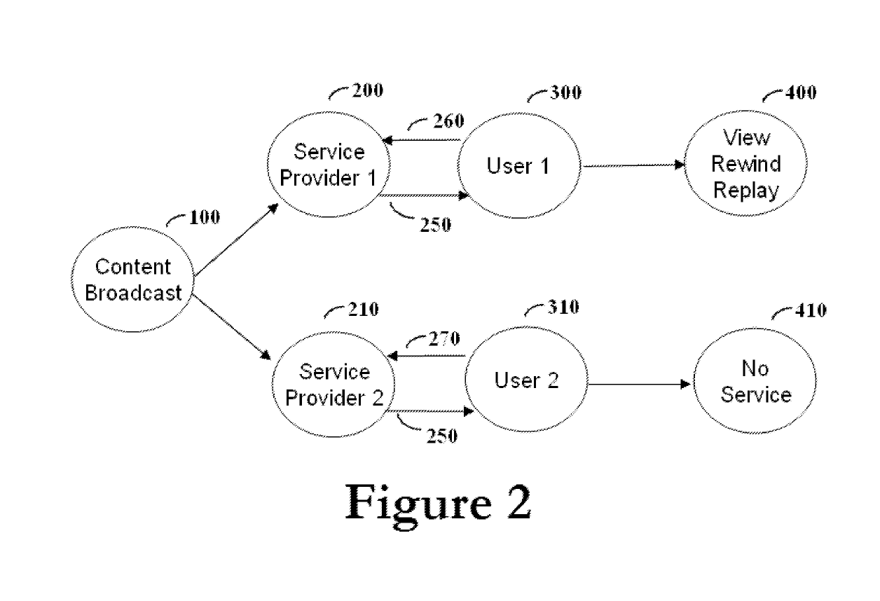

In a second embodiment, shown in FIG. 2, common data may be transmitted to a number of users attending an event, such as a concert or athletic event. Many sports fans now attend ball games bringing with them portable televisions to obtain a close-up view of certain plays. Portable devices may also be used in the same way to allow users to view instant replays or close-ups of certain plays in a game. Video data may be streamed to users within the ball park or other arena using WiFi or other transmission means (cellular or the like) and those users who subscribe to the service or enable or otherwise purchase such content may be enabled to view the content on their devices. Users who do not wish to purchase such content (or those who subscribe to a competing service or the like) may not be able to view such content.

A cellular service provider, for example, can offer this service to their subscribers for free (and not to competing providers, or for an addition fee to other networks) and thus provide an incentive to subscribe to their service. Moreover, the cellular provider may have promotional ties to a sports team or arena, and thus use the present invention to intelligently broadcast video to users in the arena as part of a loyalty and cross-promotional scheme. Since the content is being transmitted to all devices in the area simultaneously, bandwidth is conserved, as the images do not have to be separately transmitted to each user.

Referring to FIG. 2, content is broadcast at event 100 via the available service providers 200, 210. Service providers 200, 210 may comprise cellular service providers or WiFi networks or the like. Users 300, 310 receive the data 250 and may elect to purchase 260 or not to purchase 270. Alternately selection to purchase 260 or not to purchase 270 may be an indication from the user's device that it is part of a preferred network, or an enabled device. Alternately, users who are enabled to receive the service may be indicated at a central database (e.g., subscriber list) and no return signal may be required for the user to receive the media content. Users who purchase the service 300 or are enabled to receive the service may then get the feed and may watch in real time of rewind and replay events 400. Users who do not elect to purchase the service 310 or are not enable to receive the service will not be able to view the content 410.

While the preferred embodiment and various alternative embodiments of the invention have been disclosed and described in detail herein, it may be apparent to those skilled in the art that various changes in form and detail may be made therein without departing from the spirit and scope thereof.

I claim:

1. A system for intelligently broadcasting media to a plurality of users over a shared network, comprising:
at least one service provider, for providing a shared network to at least a portion of a plurality of users, for receiving at least one request for media content from at least one of the at least a portion of the plurality of users;
at least one content provider, coupled to the service provider, for receiving the request for media content and outputting the media content for transmission to the at least one user requesting the media content; and
at least one broadcast profiler, coupled to at least a portion of the plurality of users, for determining, based on user profiles, which of the at least a portion of the second plurality of users is likely to request the media content, to form at least one group of likely users,
wherein the at least one service provider intelligently broadcasts at least a portion of the media content to at least one user of the at least one group of likely users.

2. The system of claim 1, wherein user profiles are determined by one or more of: past media purchase histories of users, web browser histories of users, and search query histories of users.

3. The system of claim 1, wherein the at least a portion of the media content is stored in a media device of a likely user media device, and where the media device prompts a likely user to purchase the media content, wherein if the user purchases the media content, the media content stored in the media device is enabled for playback.

4. The system of claim 1, wherein the at least a portion of the media content is stored in a media device of a likely user media device, wherein if the user purchases the media content, the media content stored in the media device is enabled for playback.

5. The system of claim 1, wherein content is broadcast to the group of likely users during off-peak communications times.

6. A method for intelligently broadcasting media to a plurality of users over a shared network, comprising the steps of:
receiving, through at least one service provider providing a shared network to at least a portion of a plurality of users, at least one request for media content from at least one of the at least a portion of the plurality of users,
receiving, at least one content provider coupled to the service provider, the request for media content,
outputting, from the content provider, the media content for transmission to the at least one user requesting the media content,
determining, at least one broadcast profiler coupled to at least a portion of the plurality of users, based on user profiles, which of the at least a portion of the second plurality of users is likely to request the media content, to form at least one group of likely users, and
intelligently broadcasting, from the at least one service provider, at least a portion of the media content to at least one user of the at least one group of likely users.

7. The method of claim 6, wherein the step of determining user profiles comprises the step of determining user profiles by one or more of: past media purchase histories of users, web browser histories of users, and search query histories of users.

8. The method of claim 6, further comprising the steps of:
storing at least a portion of the media content in a media device of a likely user media device, and
prompting at the media device, a likely user to purchase the media content;
wherein if the user purchases the media content, the media content stored in the media device is enabled for playback.

9. The method of claim 6, further comprising the steps of:
storing at least a portion of the media content in a media device of a likely user media device, and
wherein if the user purchases the media content, the media content stored in the media device is enabled for playback.

10. The method of claim 6, wherein the step of intelligently broadcasting comprises broadcasting content to the group of likely users during off-peak communications times.

11. A system for improving bandwidth usage on networks comprising:
means for identifying groups of users interested in receiving specific content simultaneously based on previous user actions and user preferences;
means for broadcasting through a service provider, all or partial content to media devices of the groups of users, triggered by the download request of one or more users; and
means for authorizing or charging users to access the broadcast content.

12. The system of claim 11, wherein the media devices include one or more of mobile devices, fixed-base computers, fixed-base televisions, fixed-base game consuls, and fixed-base home entertainment systems.

13. The system of claim 11, wherein the service providers include one or more of terrestrial networks, wireless networks, and satellite networks.

14. The system of claim 11, wherein the means for identifying groups of users includes one or more of user profiling based on previous user actions of browsing, purchasing, sharing, recommending and downloading.

15. The system of claim 11, wherein the content includes one or more of High Definition Television (HDTV), Moving Pictures Experts Group (MPEG) video and audio formats, and Advanced Audio Coding (AAC) files.

16. The system of claim 15, wherein the content includes complete content or partial content including a lead-in or first part of a file.
